(19) United States
(12) Patent Application Publication
(10) Pub. No.: US 2015/0136673 A1
(43) Pub. Date: May 21, 2015

(54) LIQUID TREATMENT UNIT, TOILET SEAT WITH WASHER, WASHING MACHINE, AND LIQUID TREATMENT APPARATUS

(71) Applicant: Panasonic Intellectual Property Management Co., Ltd., Osaka (JP)

(72) Inventors: MARI ONODERA, Osaka (JP); MASAKI FUJIKANE, Osaka (JP); SHIN-ICHI IMAI, Osaka (JP)

(21) Appl. No.: 14/530,878

(22) Filed: Nov. 3, 2014

(30) Foreign Application Priority Data
Nov. 18, 2013 (JP) 2013-238034

(51) Int. Cl. C02F 1/30; A47K 13/30

(52) U.S. Cl. CPC C02F 1/30; A47K 13/302; C02F 2307/12; C02F 2303/04
USPC 210/192; 68/13 R; 4/233

(57) ABSTRACT

A liquid treatment unit includes: an inlet for supplying liquid; a flow passage tube connected to the inlet, the flow passage tube defining a circulation flow passage along which the liquid supplied from the inlet circulates; a plasma generator generates plasma in the liquid in at least a partial area of the flow passage tube; a distributor, provided midway in the flow passage tube, for distributing a portion of liquid from the liquid flowing through the flow passage tube; and an outlet, connected to the distributor, for ejecting the portion of liquid from the flow passage tube.

### CROSS REFERENCE TO RELATED APPLICATIONS

This application claims priority to Japanese Patent Application No. 2013-238034, filed on Nov. 18, 2013, the contents of which are hereby incorporated by reference.

### BACKGROUND

1. Technical Field

The present disclosure relates to a liquid treatment unit, a toilet seat with a washer, a washing machine, and a liquid treatment apparatus.

2. Description of the Related Art

Sterilizing apparatuses that use plasma to treat liquids such as polluted water have been proposed. For example, in the sterilizing apparatus disclosed in the specification of Japanese Patent No. 4784624, a high-voltage electrode and a grounding electrode are arranged with an interval therebetween in liquid inside a treatment tank. In a sterilization treatment apparatus configured in this manner, when a high-voltage pulse is applied between both electrodes to cause electrical discharge, plasma is generated in gas bubbles produced by the instantaneous boiling phenomenon, producing radicals such as OH, H, O, O₂⁻ and O⁻ and also H₂O₂, which destroys microorganisms and bacteria.

### SUMMARY

In apparatuses having a conventional configuration, there has been a problem concerning liquid treatment efficiency.

The present disclosure provides a liquid treatment unit, a toilet seat with a washer, a washing machine, and a liquid treatment apparatus, with which liquids are treated in an efficient manner.

A liquid treatment unit according to an aspect of the present disclosure includes: an inlet for supplying liquid; a flow passage tube connected to the inlet, the flow passage tube defining a circulation flow passage along which the liquid supplied from the inlet circulates; a plasma generator that generates plasma in the liquid in at least a partial area of the flow passage tube to cause the liquid to be treated; a distributor, provided midway in the flow passage tube, for distributing a portion of liquid from the liquid flowing through the flow passage tube; and an outlet, connected to the distributor, for ejecting the portion of liquid from the flow passage tube.

Note that these comprehensive or specific aspects may be realized by a toilet seat with a washer, a washing machine, a water purifying apparatus, an air conditioner, a humidifier, an electric shaver washer, a dish washer, a processing apparatus for hydroponic culture, an apparatus for circulating nourishing solution, a water purifier, an electric kettle, an air cleaner, a liquid treatment apparatus, or a liquid treatment method.

The liquid treatment unit, the toilet seat with a washer, the washing machine, and the liquid treatment apparatus according to the present disclosure can treat liquid in an efficient manner.

Additional benefits and advantages of the disclosed embodiments will be apparent from the specification and drawings. The benefits and/or advantages may be individually provided by the various embodiments and features of the specification and drawings, and need not all be provided in order to obtain one or more of the same.

### BRIEF DESCRIPTION OF THE DRAWINGS

FIG. 1A is a schematic diagram depicting an example of the overall configuration of a liquid treatment unit according to embodiment 1 of the present disclosure. FIG. 1B is a schematic diagram depicting an example of the way in which liquid circulates inside a flow passage tube in the liquid treatment unit according to embodiment 1.

FIG. 2A is a schematic diagram depicting an example of the overall configuration of the liquid treatment unit according to embodiment 1 of the present disclosure. FIG. 2B is a schematic diagram depicting an example of the way in which liquid circulates inside a flow passage tube in a liquid treatment unit according to a modified example of embodiment 1.

FIG. 3 is a flowchart depicting an example of the steps executed by a controller in the liquid treatment unit according to embodiment 1 of the present disclosure.

FIG. 4 is a drawing depicting the relationship between the sampling time and the sterilization rate in the liquid treatment unit according to working example 1 of the present disclosure.

FIG. 5 is a graph depicting, in a reference example, the relationship between the sampling time and the sterilization rate when Staphylococcus aureus solution is used as the liquid to be treated.

FIG. 6 is a graph depicting, in a reference example, the relationship between the sampling time and the sterilization rate when E. coli solution is used as the liquid to be treated.

FIG. 7 is a schematic diagram depicting a modified example of the configuration peripheral to a first electrode of a plasma generator in the liquid treatment unit according to embodiment 1 of the present disclosure.

FIG. 8 is a schematic diagram depicting an example of the top end of a first electrode and the configuration peripheral thereto in a plasma generator in a liquid treatment unit according to embodiment 2 of the present disclosure.

FIG. 9 is a schematic diagram depicting an example of the configuration peripheral to a first electrode of a plasma generator in a liquid treatment unit according to embodiment 3 of the present disclosure.

### DETAILED DESCRIPTION OF THE EMBODIMENTS

### Underlying Knowledge Forming Basis of the Present Disclosure

As described above, the sterilizing apparatus in the specification of Japanese Patent No. 4784624 is configured with a high-voltage electrode and a grounding electrode arranged in liquid inside a treatment tank. In a sterilizing apparatus configured in this manner, when electrical discharge is caused between the high-voltage electrode and the grounding electrode, liquid is vaporized by the instantaneous boiling phenomenon, and plasma is generated therein. Then, in the sterilizing apparatus, radicals produced by the plasma can collide with bacteria in the liquid, and liquid treatment is thereby performed.

However, in conventional sterilizing apparatuses, it has been difficult to cause radicals to collide with bacteria floating in liquid. For example, in the case where the sterilizing apparatus continuously treats liquid in a treatment tank while supplying liquid thereinto and ejecting liquid therefrom, liquid is passed therethrough tank only once. In such a case, there has been a problem in that it is difficult to increase sterilization efficiency. In other words, in conventional apparatuses, it is difficult to cause the radicals in the liquid to collide efficiently with the bacteria moving in the liquid, preventing liquid from being treated in a short time.

Therefore, the inventors took these kinds of problems of the conventional technology into consideration, and thus conceived of a novel liquid treatment apparatus. A liquid treatment apparatus constituting an aspect of the present disclosure is as follows.

A liquid treatment unit according to an aspect of the present disclosure includes: an inlet for supplying liquid; a flow passage tube connected to the inlet, the flow passage tube defining a circulation flow passage along which the liquid supplied from the inlet circulates; a plasma generator generates plasma in the liquid in at least a partial area of the flow passage tube to cause the liquid to be treated; a distributor provided midway in the flow passage tube, for distributing a portion of liquid from the liquid flowing through the flow passage tube; and an outlet, connected to the distributor, for ejecting the portion of liquid from the flow passage tube.

According to the liquid treatment unit according to an aspect of the present disclosure, at least a portion of the treated liquid which contains radicals can circulate in the flow passage tube. Liquid newly supplied into the flow passage tube can come into contact with the treated liquid circulating through the flow passage tube. In other words, the radicals present in the liquid circulating through the flow passage tube and liquid newly passing therethrough can come into contact with each other, and it is thereby possible to continuously obtain liquid that has a sterilization effect.

In the liquid treatment unit according to an aspect of the present disclosure, for example, the circulation flow passage may include a flow passage extending from the inlet to the distributor in the direction of the circulating flow, and at least part of the plasma generator may be arranged in the flow passage.

The liquid treatment unit according to an aspect of the present disclosure, for example, may further include a gas-liquid separator provided midway in the flow passage tube, the gas-liquid separator extracting gas from a mixture of the liquid and gas contained in the flow passage tube and emitting the gas to outside.

Thus, the flow rate of the liquid supplied into the flow passage tube, or the flow rate of the liquid ejected from the flow passage tube can be substantially increased.

In the liquid treatment unit according to an aspect of the present disclosure, for example, the plasma generator may include: a first electrode at least a portion of which is arranged inside the flow passage tube; a second electrode at least a portion of which is arranged inside the flow passage tube; an insulator surrounding the periphery of the first electrode with a space therebetween, the insulator having an opening through which the space communicates with the inside of the flow passage tube; a power source that applies a voltage between the first electrode and the second electrode; and a gas supply device that supplies gas to the space. For example, at least part of the first electrode may include a region where a conductor surface thereof is exposed, and when the region is covered by the gas, the power source may apply the voltage.

Thus, the plasma generator can produce radicals having a long residence time. Consequently, liquid newly supplied into the flow passage tube can be brought into contact with plasma-treated liquid that circulates through the flow passage tube. For example, when liquid newly supplied into the flow passage tube includes bacteria and/or organic matters, residual radicals and the bacteria and/or organic matters in the liquid can be made to collide with each other in an efficient manner.

In the liquid treatment unit according to an aspect of the present disclosure, for example, the plasma generator may include: a first electrode at least a portion of which is arranged inside the flow passage tube; a second electrode at least a portion of which is arranged inside the flow passage tube; an insulator surrounding the periphery of the first electrode with a space therebetween, the insulator having an opening through which the space communicates the inside of the flow passage tube; and a power source that applies a voltage between the first electrode and the second electrode. For example, at least part of the first electrode may include a region where a conductor surface thereof is exposed, and the power source may apply the voltage, vaporizing liquid inside the space to produce gas, and causing discharge when the region is covered by the gas.

Thus, the plasma generator can produce radicals having a long residence time. Consequently, liquid newly supplied into the flow passage tube can be brought into contact with plasma-treated liquid that circulates through the flow passage tube. For example, when liquid newly supplied into the flow passage tube includes bacteria and/or organic matters, residual radicals and the bacteria and/or organic matters in the liquid can be made to collide with each other in an efficient manner.

The liquid treatment unit according to an aspect of the present disclosure, for example, may further include a controller that causes liquid to be supplied to the inlet while the portion of liquid is ejected from the outlet.

Thus, liquid having a sterilization effect or sterilized liquid can be continuously ejected from the outlet while newly passes through the flow passage tube are brought into contact with the radicals present in the liquid circulating through the flow passage tube.

The liquid treatment unit according to an aspect of the present disclosure, for example, may further include a controller that controls supply of the liquid into the flow passage tube via the inlet, and ejection of the liquid from the flow passage tube via the outlet. The plasma generator may generate the plasma to cause the liquid to be treated, while the controller stops the supply of liquid and the ejection of liquid in a state where the liquid is present inside the flow passage tube. After the liquid has been treated, the controller may resume the supply of the liquid into the flow passage tube via the inlet, and cause a portion of the treated liquid to be ejected from the flow passage tube via the outlet while allowing remaining treated liquid to be circulated inside the flow passage tube.

Thus, while the supply of liquid and the ejection of liquid are performed, newly supplied liquid can be brought into contact with the circulating liquid which has been treated inside the flow passage tube. Since radicals remain in the circulating liquid, liquid newly passing through the flow passage tube and the radicals can come into contact with each other, and it is thereby possible to continuously obtain liquid that has a sterilization effect.

In the liquid treatment unit according to an aspect of the present disclosure, for example, the controller may cause the liquid to be supplied into the flow passage tube via the inlet.

In the liquid treatment unit according to an aspect of the present disclosure, for example, the plasma generator may generate the plasma in the liquid inside the flow passage tube, when the portion of the liquid is ejected while the remaining liquid is circulated inside the flow passage tube.

Thus, in addition to the step in which the supply of liquid and the ejection of liquid are stopped, plasma is generated in the liquid inside the flow passage tube also in the step in which the supply of liquid and the ejection of liquid are performed. Thus, in the step in which the supply of liquid and the ejection of liquid are performed, newly supplied liquid also can come into contact with radicals produced by the newly generated plasma. Thus, the sterilization effect can improve.

In the liquid treatment unit according to an aspect of the present disclosure, for example, when the portion of the liquid is ejected while the remaining liquid is circulated inside the flow passage tube, the quantity of the liquid ejected from the flow passage tube may be equal to or greater than the volume inside the flow passage tube.

Since the liquid is treated with a portion of the radicals which remain inside the flow passage tube, the liquid can be sufficiently treated even when the liquid is equal to or greater than the volume inside the flow passage tube.

A toilet seat with a washer according to an aspect of the present disclosure, for example, includes: the aforementioned liquid treatment unit; and a washing nozzle to which the liquid ejected from the flow passage tube is supplied.

A toilet seat with a washer according to an aspect of the present disclosure, for example, includes: the aforementioned liquid treatment unit; a washing nozzle to which the liquid ejected from the flow passage tube is supplied; and an input part that receives an instruction of washing from a user. The controller stops the supply of liquid and the ejection of liquid prior to receiving the instruction from the input part, the plasma generator generates the plasma in the liquid inside the flow passage tube, while the supply of liquid and the ejection of liquid are stopped, and the controller, based on the instruction from the input part, causes the portion of the liquid to be ejected to the washing nozzle.

A washing machine according to an aspect of the present disclosure, for example, includes the aforementioned liquid treatment unit, and a washing tub to which the liquid ejected from the flow passage tube is supplied.

A washing machine according to an aspect of the present disclosure, for example, includes the aforementioned liquid treatment unit, a washing tub to which the liquid ejected from the flow passage tube is supplied, and an input part that receives an instruction of starting washing from a user. The controller, based on the instruction from the input part, stops the supply of liquid and the ejection of liquid, the plasma generator generates the plasma in the liquid inside the flow passage tube, while the supply of liquid and the ejection of liquid are stopped, and the controller causes the portion of the liquid to be ejected to the washing tub after the liquid has been treated.

A liquid treatment apparatus according to an aspect of the present disclosure, for example, is a liquid treatment apparatus that includes the aforementioned liquid treatment unit, and a water inlet connected to the outlet of the liquid treatment unit. The liquid treatment apparatus is selected from the group consisting of a water purifying apparatus, an air conditioner, a humidifier, an electric shaver washer, a dish washer, a processing apparatus for hydroponic culture, and an apparatus for circulating nourishing solution.

Hereafter, embodiments of the present disclosure are described with reference to the drawings. Note that in all of the following drawings, the same reference numbers have been appended to the same or corresponding portions, and there are cases where redundant descriptions have been omitted.

Note that the embodiments described hereafter all represent comprehensive or specific examples. The numerical values, the shapes, the materials, the components, the arrangement of the components, the mode of connection, the steps, and the order of the steps and so forth given in the following embodiments are examples and are not intended to limit the present disclosure. A plurality of steps may be executed separately in time or may be executed at the same time. Other steps may be inserted between the steps. Components that are not described in the independent claims are described as optional constituent components.

### Embodiment 1

### Liquid Treatment Unit

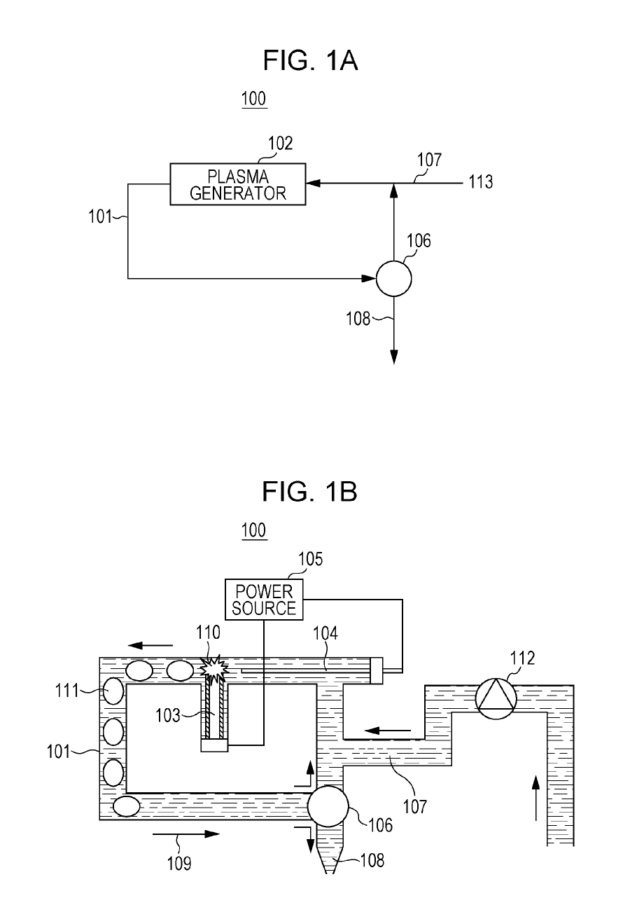

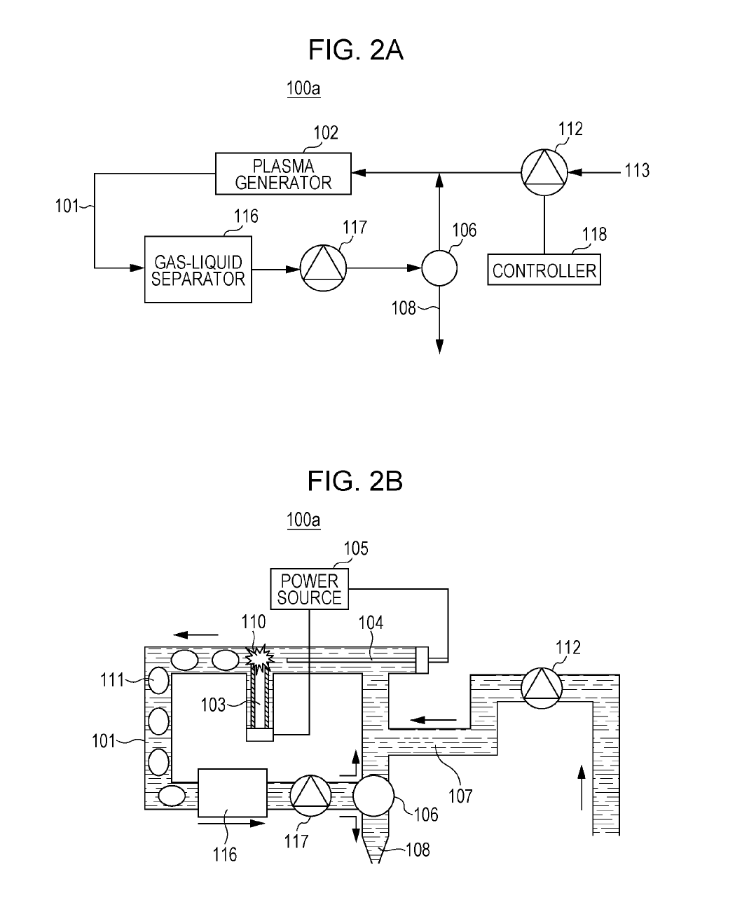

FIG. 1A is a block diagram depicting an example of the schematic configuration of a liquid treatment unit 100 according to embodiment 1. FIG. 1B is a schematic diagram depicting an example of the way in which liquid circulates inside a flow passage tube 101 in the liquid treatment unit 100 according to embodiment 1. FIG. 2A is a schematic diagram depicting an example of the overall configuration of a liquid treatment unit 100a according to a modified example of embodiment 1 of the present disclosure. FIG. 2B is a schematic diagram depicting an example of the way in which liquid circulates inside the flow passage tube 101 in the liquid treatment unit 100a according to the modified example of embodiment 1.

The liquid treatment unit 100 according to embodiment 1 includes: a flow passage tube 101 that forms a flow passage through which liquid circulates; an inlet 107 that supplies liquid to midway in the flow passage tube 101; an outlet 108 that ejects liquid from midway in the flow passage tube 101; a distributor 106; and a plasma generator 102. The distributor 106 is provided at a branch portion from the flow passage tube 101 to the outlet 108. The distributor 106 may be distribution valve, for example. The distributor 106 controls the distribution ratio of liquid with which liquid circulating through the flow passage tube 101 is distributed into liquid to be ejected from the flow passage tube 101 via the outlet 108, and liquid to circulate through the flow passage tube 101. The plasma generator 102 generates plasma 110 in liquid of at least a partial area in the flow passage tube 101. In the liquid treatment unit 100, while liquid is circulated along the flow passage tube 101, the plasma generator 102 generates the plasma 110 inside the flow passage tube 101 to produce radicals, and the circulated liquid is thereby treated. In the distributor 106, a portion of the liquid flowing through the flow passage tube 101 is ejected, and another portion is circulated to the flow passage tube 101. Since radicals remain in the circulated liquid, it is possible to treat liquid that is newly supplied from the inlet 107.

Note that “controls the distribution ratio of liquid with which liquid circulating through the flow passage tube 101 is distributed into liquid to be ejected and liquid to circulate through the flow passage tube” includes selectively switching between a mode in which the liquid that flows through the flow passage tube is not ejected, and a mode in which a portion of the liquid from the liquid that flows through the flow passage tube is ejected at a preset distribution ratio. In other words, the distributor can distribute a portion of the liquid from the liquid that flows through the flow passage tube.

The liquid treatment unit 100 may additionally include a gas-liquid separator 116 midway in the flow passage of the flow passage tube 101, as depicted in FIG. 2. The liquid treatment unit 100 may include a pump 117, located midway in the flow passage tube 101, for causing liquid to be circulated in a fixed circulation direction 109. The liquid treatment unit 100 may include a pump 112, located in the vicinity of the inlet 107, for supplying liquid into the flow passage tube 101. The liquid treatment unit 100 may include a controller 118 that controls the flow rate of the liquid inside the flow passage tube 101.

Hereafter, examples of the components that make up the liquid treatment unit 100 are described.

### <Flow Passage Tube>

The flow passage tube 101 defines the flow passage along which liquid can circulate. The liquid treatment unit 100 includes: the inlet 107 that supplies liquid to midway in the flow passage tube 101; and the outlet 108 that ejects liquid from midway in the flow passage tube 101. The pump 117 that causes liquid to be circulated in the fixed circulation direction 109 may be provided midway in the flow passage tube 101. The method for circulating liquid is not restricted to the pump 117. The pump 112 that supplies liquid into the flow passage tube 101 may be provided at the inlet 107. The flow passage tube 101 may be a material that does not react with liquid. For the flow passage tube 101, a tube may be formed from a material such as glass, plastic, silicone, or metal.

### <Distributor>

The distributor 106 is provided at a branch portion from the flow passage tube 101 to the outlet 108. The distributor 106 controls the distribution ratio with which liquid circulating through the flow passage tube 101 is distributed into liquid to be ejected from the flow passage tube 101 via the outlet 108, and liquid to circulate through the flow passage tube 101. The distributor 106 can be realized by using a distribution valve, for example.

### <Plasma Generator>

The plasma generator 102 generates the plasma 110 in liquid of at least a partial area in the flow passage tube 101. Thus, radicals are produced in the liquid, and thereby the circulated liquid is treated. A plurality of the plasma generators 102 may be provided in the flow passage tube 101. The plasma generator 102 may be provided in the flow passage tube 101 at a location between the inlet 107 branch portion and the outlet 108 branch portion in the circulation direction 109 of the liquid. The plasma generator 102, for example, may include: a first electrode 103 at least a portion of which is arranged inside the flow passage tube 101; a second electrode 104 at least a portion of which is arranged inside the flow passage tube 101; and a power source 105 that applies a voltage between the first electrode 103 and the second electrode 104.

### <First Electrode>

At least a portion of the first electrode 103 may be arranged inside the flow passage tube 101. The arrangement of the first electrode 103 is not particularly restricted as long as the first electrode 103 is arranged inside the flow passage tube 101. The first electrode 103, for example, is formed from a material such as iron, tungsten, copper, aluminum, platinum, or an alloy including one or more metals selected from these metals. In order to prolong the electrode life span, yttrium oxide added with a conductive material may be thermally sprayed in a portion of the surface of the first electrode 103. Yttrium oxide added with a conductive material may have electric resistivity of 1 to 30 Ωcm, for example. In the examples depicted in FIG. 1 and FIG. 2, the shape of the first electrode 103 is tubular, or cylindrical, with an opening at one end thereof that faces the flow passage tube 101. However, the shape of the first electrode 103 is not limited to this shape.

### <Second Electrode>

At least a portion of the second electrode 104 may be arranged in the flow passage tube 101. The arrangement of the second electrode 104 is not particularly restricted as long as the second electrode 104 is arranged inside the flow passage tube 101. The second electrode 104 may be formed from a conductive metal material. For example, as with the first electrode 103, the second electrode 104 is formed from a material such as iron, tungsten, copper, aluminum, platinum, or an alloy including one or more metals selected from these metals.

### <Power Source>

The power source 105 is arranged between the first electrode 103 and the second electrode 104. The power source 105 applies a high-frequency AC voltage between the first electrode 103 and the second electrode 104. The frequency of the AC voltage may be 1 kHz or greater, for example. The power source 105 may alternately apply a positive pulse voltage and a negative pulse voltage, namely a bipolar pulse voltage. By using a bipolar pulse voltage, it is possible to prolong the life spans of the electrodes.

### <Gas-Liquid Separator>

The liquid treatment unit 100 may include the gas-liquid separator 116 midway in the flow passage of the flow passage tube 101, as depicted in FIG. 2. The gas-liquid separator 116 extracts gas from a mixture of liquid and gas in the flow passage tube 101 and emits the gas to outside. Thus, it is possible to increase the actual flow rate of the liquid that circulates through the flow passage tube 101.

### <Controller>

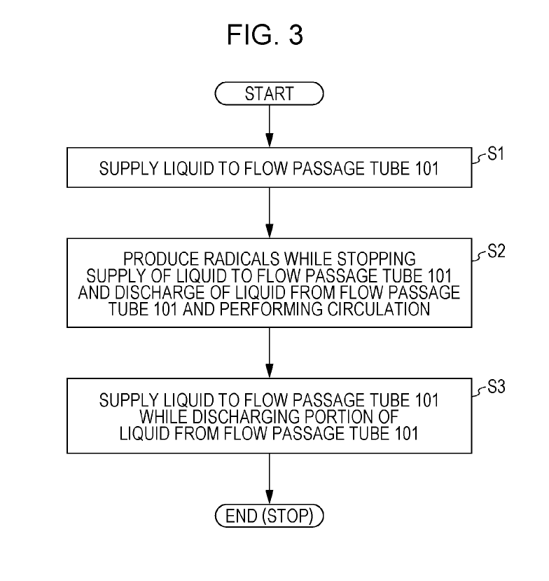

The liquid treatment unit may have the controller 118 that controls the flow rate of the liquid inside the flow passage tube 101. An example of a flowchart that includes steps executed by the controller 118 is depicted in FIG. 3. The first step (S1) to the third step (S3) described hereafter represent a series of liquid treatment steps.

In the first step (S1), liquid is supplied into the flow passage tube 101 via the inlet 107. However, when liquid of a specific quantity or more is already present inside the flow passage tube 101, the first step may be omitted.

After the first step, or in a state where liquid of a specific quantity or more is present inside the flow passage tube 101, the second step (S2) is executed. In the second step (S2), the supply of liquid into the flow passage tube 101 via the inlet 107 and the ejection of liquid from the flow passage tube 101 via the outlet 108 are stopped for a predetermined time. In other words, liquid remains inside the flow passage tube 101 for the predetermined time while circulating therein. The time of the second step may be appropriately set in accordance with the length of the residence time of the radicals, the volume of the flow passage tube 101, the type and quantity of bacteria and/or organic compounds in the liquid, and the flow rate of the liquid supplied in the subsequent third step (S3), for example.

After the second step, in the third step (S3), newly liquid is supplied into the flow passage tube 101 via the inlet 107 while a portion of the liquid flowing through the flow passage tube 101 is ejected from the flow passage tube via the outlet 108. At such time, the timing at which the ejection of liquid is started and the timing at which the supply of liquid is started do not have to coincide completely. The flow rate of the liquid that is ejected or supplied and the period of the third step may be appropriately set in accordance with the length of the residence time of the radicals that are produced, the volume of the flow passage tube 101, and the type and quantity of bacteria and/or organic compounds in the liquid, for example.

In this case, in the second step, the plasma generator 102 generates plasma in the liquid inside the flow passage tube 101, to produce radicals, thereby causing the liquid to be treated.

The second step and the subsequent third step may be executed once again after a predetermined quantity of liquid has been ejected in the third step.

Note that in the present disclosure, when “the supply of liquid into the flow passage tube is resumed”, the liquid may be the same type of liquid as the liquid that has been supplied into the flow passage tube prior thereto, or may be different liquid. For example, the liquid supplied into the flow passage tube in the first step may be pure water or tap water, and the liquid supplied into the flow passage tube in the third step may be polluted water that includes bacteria and/or organic matters.

The plasma generator 102 may generate plasma in the liquid inside the flow passage tube 101 in the first step and/or the third step in addition to the second step. In addition to the second step, for example, as a result of plasma being generated in the third step, the liquid that is newly supplied in the third step can come into contact also with radicals that are produced by the plasma generated in the third step. Thus, the sterilization rate can improve.

In the third step, the controller may ejection liquid of a volume equal to or greater than that of the flow passage tube 101. When liquid of a volume equal to or greater than that of the flow passage tube 101 is ejected, the ejected liquid inevitably includes the liquid that is newly supplied in the third step. When the residence time of the radicals produced by the plasma is long, the liquid that is newly supplied in the third step can come into contact with the radicals to a greater extent, thereby enabling liquid to be ejected in a sufficiently sterilized state.

The controller 118 may circulate, inside the flow passage tube 101, at least a portion of the liquid that is supplied as result of the execution of the first step or the third step.

The controller 118 supplies liquid into the flow passage tube 101 in the first step, and performs plasma treatment while the liquid is retained inside the flow passage tube 101 in the second step. Germs present in the liquid inside the flow passage tube 101 are killed and/or organic matters present in the liquid inside the flow passage tube 101 are decomposed by active species including radicals produced by the plasma. In this case, some radicals remain in the liquid. When the supply of newly liquid and the ejection of the treated liquid are performed in the third step, a portion of the liquid that has been treated in the second step is retained inside the flow passage tube 101 due to the shape of the flow passage tube 101. In other words, a portion of the liquid that has been treated in the second step comes into contact with the newly supplied liquid, in a mixed state inside the flow passage tube 101. As previously mentioned, radicals produced by the plasma remain in the retained liquid. As a result, the liquid newly supplied into the flow passage tube 101 can come into contact with the radicals in the retained liquid, thus causing a sterilization effect.

The first step to the third step may be directly executed by the controller 118, or may be indirectly executed based on an instruction from the controller 118. For example, when liquid is to be supplied into the flow passage tube 101 via the inlet 107, the controller 118 may operate the pump 112 provided at the inlet 107 to supply the liquid into the flow passage tube 101. For example, the controller 118 may cause liquid to be ejected from the flow passage tube 101 via the outlet 108, thereby causing liquid to be supplied in a quantity that is approximately the same as the quantity ejected into the flow passage tube 101 via the inlet 107 because of changes in pressure inside the flow passage tube 101, into the flow passage tube 101 via the inlet 107. For example, the controller 118 may causes liquid to be supplied into the flow passage tube 101 via the inlet 107, thereby causing liquid to be ejected in a quantity that is approximately the same as the quantity supplied from the flow passage tube 101 via the outlet 108 because of changes in pressure inside the flow passage tube 101.

### Modified Example of a Plasma Generator

Next, a modified example of a first electrode 103a and the configuration peripheral thereto, which are included in the plasma generator 102 of the liquid treatment unit 100 according to embodiment 1, is described.

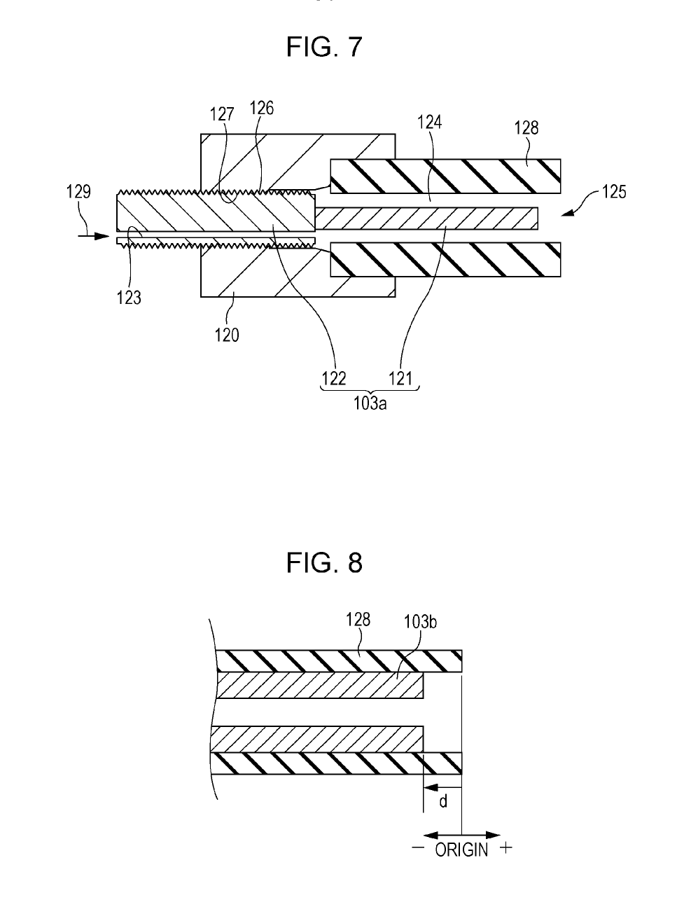

FIG. 7 is a cross sectional view depicting a modified example of the first electrode 103a and the configuration peripheral thereto, that are included in the plasma generator 102. As depicted in FIG. 7, the first electrode 103a has an electrode portion 121 at one end side and a support portion 122 at the other end side. The electrode portion 121 is arranged inside the flow passage tube 101. The support portion 122 is connected and fixed to a holding block 120, and is also connected to the power source 105. The electrode portion 121 is formed from a columnar conductor, for example. Columnar, for example, is a shape in which the diameter from one end to the other end of the electrode portion 121 does not change substantially. As result of employing this kind of shape, compared to a shape that becomes thinner toward the tip and has no substantial thickness at the endmost section such as a needle shape, it is possible to suppress an excessive concentration in the electric field toward the top end, and it is possible to suppress deterioration due to use. An insulator 128 is provided with a space 124 between the insulator 128 and the electrode portion 121. The insulator 128 has an opening 125 at one end side thereof, which is located inside the flow passage tube 101. A through hole 123 is provided inside the support portion 122. A gas supply device (not depicted) is connected to the through hole 123. Gas supplied from the gas supply device is supplied to the space 124 via the through hole 123. When the gas is supplied to the space 124, a gas bubble 111 is generated in the liquid via the opening 125.

In the first electrode 103a, the electrode portion 121 and the support portion 122 may have different sizes, and may be formed from metal electrodes of different materials. As an example, the electrode portion 121 may have a diameter of 0.95 mm and tungsten may be used as the material therefor, and the support portion 122 may have a diameter of 3 mm and iron may be used as the material therefor. Here, the diameter of the electrode portion 121 may be 2 mm or less, for example, as long as it is a diameter at which plasma is generated. The material of the electrode portion 121 is not restricted to tungsten, and another plasma-resistant metal material may be used. For the material of the electrode portion 121, although there is deterioration in durability, copper, aluminum, iron, or an alloy thereof may be used, for example. Yttrium oxide added with a conductive material may be thermally sprayed in a portion of the surface of the electrode portion 121. Yttrium oxide added with a conductive material has electric resistivity of 1 to 30 Ωcm, for example. The electrode life span is prolonged by thermally spraying the yttrium oxide. The diameter of the support portion 122 is not restricted to 3 mm, and it is sufficient as long as that dimension is greater than the diameter of the electrode portion 121. The material of the support portion 122 is a metal material that is easy to process, and may be copper, zinc, aluminum, tin, or brass or the like, which are materials that are used for typical screws. The first electrode 103a can be formed by pressing the electrode portion 121 into the support portion 122 to thereby form a single unit, for example. In this way, since a highly plasma-resistant metal material is used for the electrode portion 121, and an easily processable metal material is used for the support portion 122, it is possible to realize a first electrode 103a having stable characteristics that has low manufacturing costs while also being plasma resistant.

The support portion 122 may have the through hole 123 that passes through to the gas supply device (not depicted). The through hole 123 is connected to the space 124, and the gas 129 from the gas supply device is supplied to the space 124 via the through hole 123. The electrode portion 121 is then covered by the gas 129 supplied from the through hole 123. When electrode portion 121 has a single through hole 123, the through hole 123 is located at the lower side of the electrode portion 121 in the gravity direction as depicted in FIG. 7, thereby causing the electrode portion 121 to be covered by the gas 129 easily. When electrode portion 121 has a single through hole 123 two or more through holes 123, it is possible to suppress pressure loss in the through holes 123. The diameter of the through hole 123 is 0.3 mm, for example.

A screw 126 may be provided at the outer periphery of the support portion 122. For example, if the screw 126 at the outer periphery of the support portion 122 is a male screw, the holding block 120 may have a screw 127 that is a female screw. Thus, the screws 126 and 127 can be screwed together, and thereby the first electrode 103a can be fixed to the holding block 120. By rotating the support portion 122, it is possible to accurately adjust the position of the end surface of the electrode portion 121 related to the opening 125 of the insulator 128. The first electrode 103a may be connected to the power source 105 with the screw 126. Thus, the contact resistance of the power source 105 and the first electrode 103a can stabilize, and thus the characteristics of the first electrode 103a can stabilize. When the gas supply device (not depicted) and the first electrode 103a are connected and fixed with the screw 126, the connection therebetween can be implemented in a reliable manner. This kind of arrangement is related to waterproofing measures and safety measures when put into practical use.

The method for holding the electrode portion 121 is not limited to the aforementioned. It is sufficient as long as the gas bubble can be formed in liquid from the opening 125 of the insulator 128 by supplying the gas 129 to the space 124.

The insulator 128, which has an internal diameter of 1 mm, for example, is arranged around the periphery of the electrode portion 121 with the space 124 between the electrode portion 121 and the insulator 128. In the space 124, the gas 129 is supplied from the gas supply device, and thereby the electrode portion 121 is covered by the gas 129. Therefore, the outer periphery of the electrode portion 121 does not come into direct contact with liquid even though the metal of the electrode is exposed. The opening 125 is provided in the insulator 128, and has the function of determining the size of the gas bubble 111 when the gas bubble 111 is generated in the liquid inside the flow passage tube 101. The insulator 128 may be formed from a material such as aluminum oxide, magnesium oxide, yttrium oxide, insulative plastic, glass, or quartz.

The opening 125 of the insulator 128 may be arranged in the liquid inside the flow passage tube 101. In other words, although the opening 125 is provided at the end surface of the insulator 128 as depicted in FIG. 7, the opening 125 may be provided at the side surface of the insulator 128. A plurality of openings 125 may be provided in the insulator 128. The diameter of the opening 125 is 1 mm, as an example.

The second electrode 104 may be made of conductive metal materials; for example, copper, aluminum, or iron or the like, but is not limited to this.

A pump may be used as the gas supply device, for example. Air, He, Ar, or O₂ or the like is used for the gas 129 that is supplied, for example. The flow rate may be selected from the range of 0.5 L/min. to 2.0 L/min., for example, but is not limited to this.

The power source 105 applies a pulse voltage or an AC voltage between the first electrode 103a and the second electrode 104.

### (Production of Radicals)

The production of radicals by the plasma generator 102 according to the modified example depicted in FIG. 7 will now be described.

The gas supply device (not depicted) supplies the gas 129 to the space between the first electrode 103a and the insulator 128 in a state where liquid is present inside the flow passage tube. The gas 129 is emitted into the liquid inside the flow passage tube 101 via the opening 125 of the insulator 128. At such time, a columnar gas bubble that covers the electrode portion 121 of the first electrode 103a is formed in the liquid. The gas bubble is a single large gas bubble extending from the opening 125 of the insulator 128 for a specific distance (10 mm or more, for example). In other words, since the gas 129 flows through the space 124 between the electrode portion 121 of the first electrode 103a and the insulator 128, the electrode portion 121 of the first electrode 103a is ordinarily covered by the gas 129. At such time, the surface of the electrode portion 121 of the first electrode 103a does not come into direct contact with the liquid.

Note that in the present disclosure, “the surface of the first electrode does not come into direct contact with the liquid” refers to the surface of the first electrode not coming into contact with a large mass of liquid inside the flow passage tube. Therefore, for example, the state where “the surface of the first electrode does not come into direct contact with the liquid” includes the state where the surface of the first electrode is wet with liquid (strictly speaking, the surface of the first electrode is in contact with the liquid) and covered by the gas inside the gas bubble. It is possible for this kind of state to occur, for example, when a gas bubble is generated while the surface of the first electrode is wet with liquid.

As mentioned above, after the surface of the electrode portion 121, or exposed conductor portion, of the first electrode 103a has been covered by the gas bubble 111, the power source 105 applies a high-frequency AC voltage or a pulse voltage between the first electrode 103a and the second electrode 104. This causes an electrical discharge inside the gas bubble 111 in the vicinity of the first electrode 103a, and thereby plasma 110 is generated. The voltage value or the current value output by the power source 105 may be a value of a range with which glow discharge is generated. Although the plasma 110 spreads to the entirety of the gas bubble 111, highly concentrated plasma 110 is formed particularly in the vicinity of the first electrode 103a. Radicals and so forth that sterilize the liquid and/or decompose chemical substances included in the liquid are produced by the plasma 110. There are no particular limitations regarding the distance between the first electrode 103a and the second electrode 104.

According to the modified example of the plasma generator 102 depicted in FIG. 7, radicals having a long residence time can be produced. To be specific, it has been confirmed that it is possible to produce OH radicals having a life span of approximately 10 min. from the generation of plasma being stopped. The life span of the OH radicals is the half-life of the OH radical quantity calculated by measuring the OH radical quantity at each predetermined time using the electron spin resonance (ESR) method after the plasma has stopped.

### (Liquid Treatment Method)

An example of a liquid treatment method in which the liquid treatment unit 100 according to embodiment 1 is used will now be described.

(1) First the inside of the flow passage tube 101 is filled with liquid (first step).

(2) Next, the plasma generator 102 generates plasma 110 inside the flow passage tube 101 for a predetermined time while liquid is circulated inside the flow passage tube 101, thus causing the circulated liquid to be treated (second step). This treatment is referred to as prior plasma treatment. As a result of the prior plasma treatment, the liquid circulating through the flow passage tube 101 can be treated. Radicals having a long residence time remain in the treated liquid.

(3) Next, at the same time that a portion of the liquid that flows through the flow passage tube 101 is ejected from the flow passage tube 101 via the outlet 108, new liquid is supplied into the flow passage tube 101 via the inlet 107, thus causing liquid inside the flow passage tube 101 to be treated (third step).

A portion of the liquid to be treated may be supplied into the flow passage tube 101 in the first step, and the remaining liquid to be treated may be supplied into the flow passage tube 101 in the third step. In this case, prior to performing the third step, the prior plasma treatment is performed in advance for a portion of the liquid to be treated.

In the liquid treatment units 100 and 100a according to embodiment 1 of the present disclosure, since radicals having a long residence time are produced in at least a portion of the flow passage tube 101 by the plasma generator 102, the radicals and bacteria can be brought into contact with each other for a long period of time while the liquid is circulated, thus causing the liquid to be sterilized in an efficient manner. Treated liquid circulates through the flow passage tube 101 together with new liquid supplied into the flow passage tube 101. Many radicals remain in the circulated liquid. Therefore, when new liquid is supplied into the flow passage tube 101, the newly supplied liquid can be treated by the radicals included in the treated liquid that circulates inside the flow passage tube 101.

The plasma 110 may be generated inside the flow passage tube 101 by the plasma generator 102 in the third step in addition to the second step. Thus, in the third step, when new liquid is supplied into the flow passage tube 101, the newly supplied liquid can be treated by not only the radicals remaining in the treated liquid that circulates inside the flow passage tube 101 but also by the radicals that are newly produced by the plasma generator 102.

The plasma generator 102 that can produce radicals having a long residence time is not limited to the configuration indicated in embodiment 1 of the present disclosure. The inventors have confirmed that it is possible to produce radicals having a long residence time also in plasma generators having the configurations described in embodiment 2 and embodiment 3 described hereafter. A plasma generator having another configuration can be effectively applied in the liquid treatment unit of the present disclosure as long as radicals having a long residence time can be produced.

### Working Example 1

Working example 1 is an example in which liquid treatment is executed using a liquid treatment unit which includes a flow passage tube defining a circulation flow passage of the liquid, and a plasma generator having the first electrode 103a and the configuration peripheral thereto as depicted in FIG. 7.

The overall configuration of the liquid treatment unit 100a of working example 1 was as depicted in FIG. 2. To be specific, the flow passage tube 101 was a silicone hose having an internal diameter of 5 mm and a volume of 250 mL.

The first electrode 103a and the configuration peripheral thereto in the plasma generator 102 of working example 1 were as depicted in FIG. 7. To be specific, the electrode portion 121 was made of tungsten, and the diameter thereof was 0.95 mm. The support portion 122 was made of iron, and the diameter thereof was 3 mm. The through hole 123 of the support portion 122 had a diameter of 0.3 mm. The insulator 128 was formed from alumina ceramic, and had an internal diameter of 1 mm. The opening 125 provided in the insulator 128 had a diameter of 1 mm. The interval between the electrode portion 121 and the insulator 128 was 0.05 mm. The distance between the first electrode 103a and the second electrode 104 was 10 mm. The second electrode 104 was arranged upstream in the circulation direction 109 from the first electrode 103a. The second electrode 104 was made of tungsten, and the diameter was 1 mm. The gas supply quantity supplied from the through hole 123 was 1 L/min. The power source 105 that applies a voltage between the first electrode 103a and the second electrode 104 was capable of applying a pulse voltage. The output capacity thereof was 80 VA, and for the peak voltage at no load, a voltage of 10 kV was able to be applied.

The procedure for the liquid treatment method in working example 1 is as follows.

(1) A portion of Staphylococcus aureus solution to be treated was supplied into the flow passage tube 101 (first step). The bacteria quantity in the Staphylococcus aureus solution was approximately 1×104 cfu/mL. The volume of the flow passage tube 101 to which the Staphylococcus aureus solution was supplied was approximately 250 mL. The capacity of 250 mL was half of the 500 mL of liquid to be treated.

(2) Next, the plasma generator 102 generated the plasma 110 inside the flow passage tube 101 for 30 minutes while liquid was circulated inside the flow passage tube 101, and thereby the circulated liquid was treated (second step). This treatment is performed in advance for a portion of the liquid to be treated, and is therefore referred to as prior plasma treatment. As a result of the prior plasma treatment, the liquid circulating through the flow passage tube 101 was treated and sterilized, and radicals remained in the liquid.

(3) Next, while the plasma 110 was generated inside the flow passage tube 101 by the plasma generator 102, a portion of the liquid flowing through the flow passage tube 101 was ejected from the flow passage tube 101 via the outlet 108, and also the remaining Staphylococcus aureus solution was supplied into the flow passage tube 101 via the inlet 107, and thus liquid was then treated (third step). The Staphylococcus aureus solution was supplied into the flow passage tube 101 at a flow velocity of 0.5 L/min. The flow velocity of the liquid ejected from the flow passage tube 101 was 0.5 L/min, and the quantity of the liquid was 250 mL. The distribution ratio of the distributor 106 at such time was 1:1, and half of the liquid that flowed through the flow passage tube 101 was ordinarily recirculated inside the flow passage tube 101. In this way, a portion of the treated liquid was circulated to the flow passage tube 101 together with new liquid being supplied. Thus, it is possible to treat the newly supplied liquid by using the residual radicals included in the circulated liquid, and the radicals that are newly generated by the plasma generator 102.

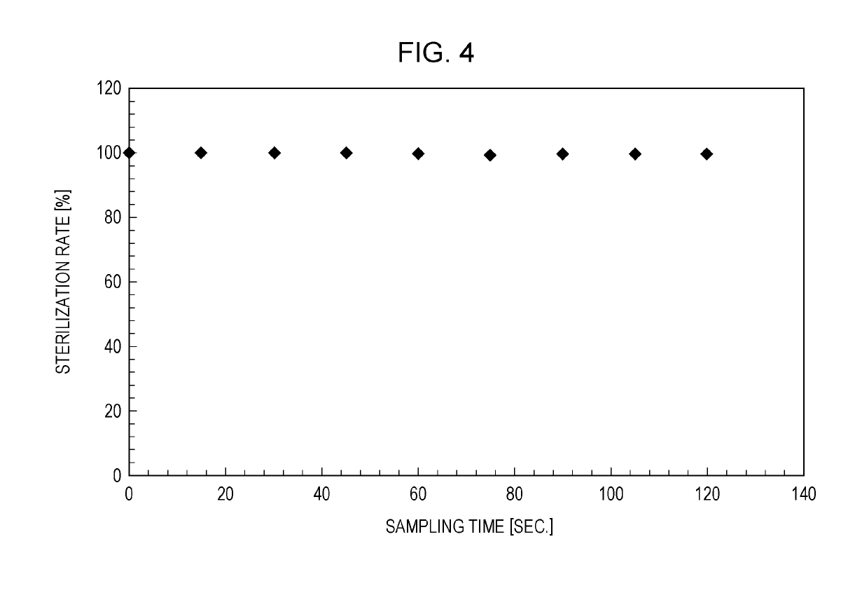

FIG. 4 is a graph depicting the relationship between the sterilization rate of Staphylococcus aureus in liquid obtained from the outlet 108 and time. The horizontal axis in FIG. 4 indicates elapsed time in which 0 minutes is immediately after ejection from the outlet 108 has been started. The vertical axis in FIG. 4 indicates the sterilization rate. As a result, as depicted in FIG. 4, solution having a sterilization rate of 99% or more was continuously obtained, and the total quantity of 500 mL of liquid was able to be sterilized.

Liquid subjected to prior plasma treatment is sequentially ejected from inside the flow passage tube 101 via the outlet 108. Accordingly, after 30 seconds in which liquid of a quantity corresponding to the total quantity of the liquid subjected to prior plasma treatment has already been ejected, the sterilization rate is expected to decline. However, as mentioned above in working example 1, a portion of the treated liquid is circulated to the flow passage tube 101. Thus, it was possible to treat the newly supplied liquid by using the radicals included in the circulated liquid, and the radicals sequentially generated by the plasma generator 102. As a result, it is thought that it was possible to continuously obtain solution having a sterilization rate of 99% or more.

### Reference Example

In the reference example, compared to working example 1, the liquid treatment unit does not include the distributor 106 for distributing a portion of the liquid from the liquid that flows through the flow passage tube 101. To be specific, the liquid treatment unit of the reference example is only able to select a mode in which none of the liquid that flows through the flow passage tube 101 is ejected, and a mode in which all of the liquid is ejected. In other words, the reference example differs with working example 1 in that, in the third step, none of the liquid flowing through the flow passage tube 101 is recirculated to the flow passage tube 101. The data of the reference example was acquired by employing the same liquid treatment unit 100a as in the working example but without using the distribution function of the distributor 106.

The specific liquid treatment procedure in the reference example is as follows.

(1) First a portion of the Staphylococcus aureus solution or the E. coli solution to be treated was supplied into the flow passage tube 101. In the case of the Staphylococcus aureus solution, the bacteria quantity was approximately 1×104 cfu/mL. In the case of the E. coli solution, the bacteria quantity was approximately 1×104 cfu/mL. The volume of the flow passage tube 101 was approximately 250 mL.

(2) Prior plasma treatment was performed for a predetermined time while liquid was circulated inside the flow passage tube 101. In the case of the Staphylococcus aureus solution, prior plasma treatment was performed for 10 min. or 15 min. In the case of the E. coli solution, prior plasma treatment was performed for 20 min. or 30 min.

(3) Next, while the plasma 110 was generated, together with a portion of the liquid being ejected from the outlet 108, the Staphylococcus aureus solution or the E. coli solution was supplied into the flow passage tube 101 for the liquid to be treated. In the case of the Staphylococcus aureus solution and in the case of the E. coli solution, the solution was supplied into the flow passage tube 101 at a flow velocity of 0.5 L/min. In the case of the Staphylococcus aureus solution and in the case of the E. coli solution, the flow rate of the liquid ejected from the flow passage tube 101 was 0.5 L/min. At such time, the distribution ratio of the distributor 106 was 1:0. In other words, the total quantity of the liquid supplied into the flow passage tube 101 was ejected from the outlet 108 without being circulated through the flow passage tube 101. Other conditions such as the power source and the configuration of the plasma generator were the same as in working example 1.

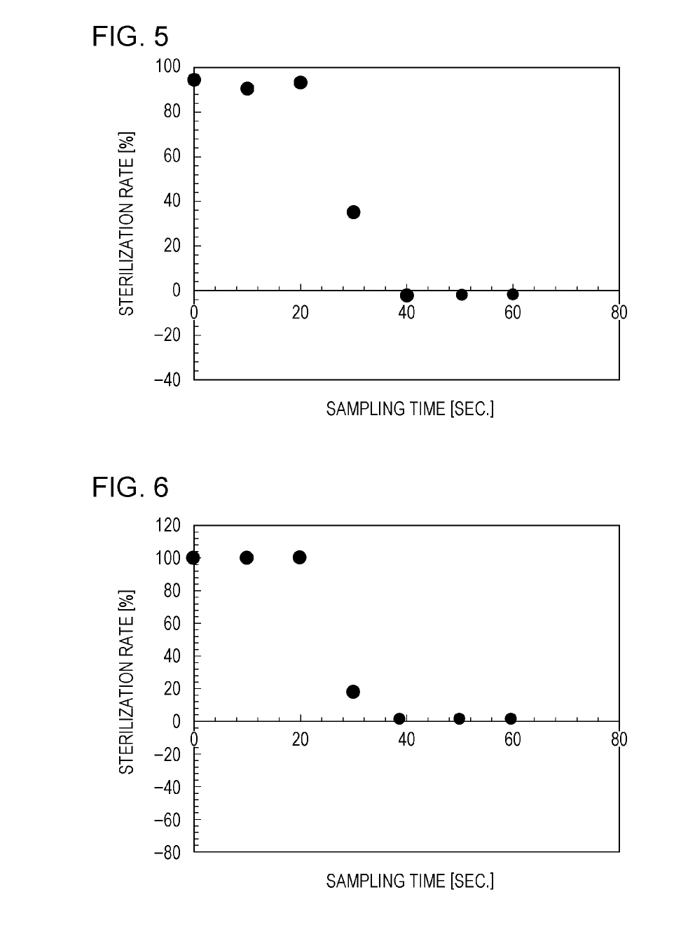

FIG. 5 is a graph depicting the relationship between the sterilization rate of liquid obtained from the outlet 108 and time when Staphylococcus aureus solution was used as the liquid to be treated. FIG. 6 is a graph depicting the relationship between the sterilization rate of liquid obtained from the outlet 108 and time when E. coli solution was used as the liquid to be treated. The horizontal axes in FIG. 5 and FIG. 6 indicate elapsed time in which 0 minutes is immediately after ejection from the outlet 108 has been started. The vertical axes in FIG. 5 and FIG. 6 indicate the sterilization rate. As depicted in FIG. 5 and FIG. 6, liquid for which prior plasma treatment has been performed was ejected from 0 to 30 seconds, and solution having a sterilization rate of 99% or more was continuously obtained in each case. However, after 30 seconds, newly supplied Staphylococcus aureus solution or E. coli solution was ejected, and the sterilization rate deteriorated.

This is thought to be because there is no liquid circulated through the flow passage tube 101 by the distributor 106 at all, and liquid including radicals produced by the plasma generator 102 is ejected, and therefore it is no longer possible for bacteria in the newly supplied Staphylococcus aureus solution or the E. coli solution to be sufficiently killed.

### Embodiment 2

In contrast with the liquid treatment unit according to embodiment 1, the liquid treatment unit according to embodiment 2 is different with respect to the first electrode and the configuration peripheral thereto in the plasma generator.

FIG. 8 is an enlarged view depicting an example of a first electrode 103b and the configuration peripheral thereto that are part of a plasma generator in the liquid treatment unit according to embodiment 2. The first electrode 103b is formed from metal, for example. The first electrode 103b has a shape with openings at both ends thereof, or hollow cylindrical shape, for example. A tubular insulator 128 is arranged adhered to the outer peripheral surface of the first electrode 103b. The insulator 128 is cylindrical, for example. The insulator 128 is formed from alumina ceramic, for example. The insulator 128 may be configured from titanium oxide, for example.

A gas supply device is connected to the opening at one end of the first electrode 103b. Gas 129 supplied from the gas supply device passes through an internal space in the first electrode 103b, and is emitted into liquid as a gas bubble, from the opening at the other end of the first electrode 103b. The insulator 128 may be configured to be slidable with respect to the first electrode 103b.

With the aforementioned configuration, when gas is continuously supplied to the opening at one end of the first electrode 103b, a gas bubble is formed in the liquid, from the opening at the other end of the first electrode 103b. The gas bubble is a columnar gas bubble having dimensions such that the gas therein covers the opening at the other end of the first electrode 103b, or in other words, the opening at the other end of the first electrode 103b is positioned inside the gas bubble. The end surface of the first electrode 103b, which is located in the vicinity of the opening at the other end thereof, is not covered by the insulator 128, and thus a conductor of the end surface is exposed. Therefore, by using the gas supply device to appropriately set the gas supply quantity, a state is maintained in which the vicinity of the opening at the other end of the first electrode 103b is covered by gas inside a gas bubble. In other words, the gas supply device can supply the gas 129 to the first electrode in such a way that, from within the surface of the first electrode 103b so that at least the exposed conductor surface of the first electrode 103b is positioned inside the gas bubble in the treatment tank 101. The insulator 128 formed from alumina ceramic, for example, is arranged at the outer peripheral surface of the first electrode 103b. Therefore, the surface of the first electrode 103b is configured in such a way that, due to the insulator 128 and the gas bubble, it is possible to achieve a state where direct contact is not made with the liquid.

The power source 105 applies a voltage between the first electrode 103b and a second electrode 104 after a state is reached where the exposed portion of the conductor of the first electrode 103b is positioned inside the gas bubble. The operation thereafter is the same as in embodiment 1.

### Embodiment 3

In contrast with the liquid treatment unit according to embodiment 1, the liquid treatment unit according to embodiment 3 is different with respect to the first electrode and the configuration peripheral thereto in the plasma generator. The liquid treatment unit according to embodiment 3 does not have a gas supply device.

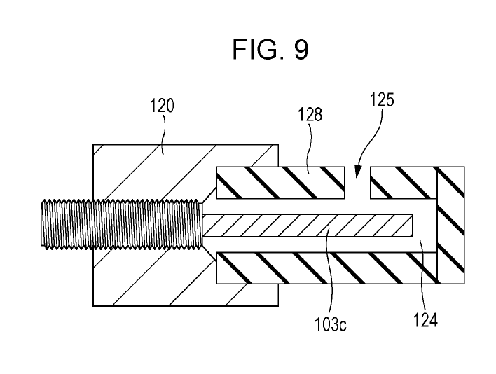

FIG. 9 is a cross sectional view depicting an example of a first electrode 103c and the configuration peripheral thereto that form part of a plasma generator in the liquid treatment unit according to embodiment 3. As depicted in FIG. 9, an insulator 128 surrounds the periphery of the first electrode 103c with a space 124 therebetween. The insulator 128 has at least one opening 125 through which the space 124 communicates the inside of the flow passage tube 101. This configuration allows liquid inside the flow passage tube 101 to enter into the space 124 through the opening 125, and thus the space 124 is filled with the liquid. One end of the first electrode 103c and one end of the insulator 128 are fixed to a holding block 120. The method for fixing the first electrode 103c and the insulator 128 is not limited to this. A second electrode 104 may be arranged in any position in the flow passage tube 101, and there are no restrictions regarding the arrangement position.

The operation of a plasma generator including the first electrode 103c is as follows.

Prior to starting the liquid treatment, the space 124 formed between the first electrode 103c and the insulator 128 is filled with liquid. In this state, a power source 105 applies a high-frequency AC voltage or a pulse voltage between the first electrode 103c and the second electrode 104, thereby heating the liquid inside the space 124.

The temperature of the liquid inside the space 124 rises due to the electrical power provided from the first electrode 103c. This rise in temperature causes the liquid inside the space 124 to vaporize, and thus gas is generated. The gas forms a mass while gathering inside the space 124. Plasma is then generated due to electrical discharge occurring inside the mass of gas, or in other words, inside a gas bubble. Active species such as radicals are produced by the plasma. This enables the liquid to be sterilized and/or enables chemical substances included in the liquid to be decomposed by such gas bubbles.

In the liquid treatment units 100 and 100a according to embodiments 1 to 3, radicals having a long life span can be produced in liquid inside the flow passage tube 101 by the plasma generator 102, and then the liquid including the radicals can be circulated inside the flow passage tube 101. Thus, the radicals can be brought into contact with bacteria in the liquid for a long period of time, and thereby the liquid can be treated. Since a portion of the treated liquid is recirculated to the flow passage tube 101 by the distributor 106, newly supplied liquid can be effectively treated with the radicals having a long life span included in the circulated liquid.

In the liquid treatment units 100 and 100a according to embodiments 1 to 3, the plasma generator 102 is arranged inside the flow passage tube 101 through which liquid is circulated. The plasma generator 102 has a configuration with which a voltage is applied between the first electrode 103 and the second electrode 104. With this configuration, the power source 105 applies a voltage between the first electrode 103 and the second electrode 104, thereby generating the plasma 110 in the liquid inside the flow passage tube 101 to produce radicals having a long life span time. Thus, bacteria present in the liquid that circulates inside the flow passage tube 101 can be treated.

In embodiments 1 to 3, the first electrode 103 and the configuration peripheral thereto are exemplified. Therefore, the liquid treatment unit of the present disclosure is not limited to the first electrode and the configuration peripheral thereto indicated in embodiments 1 to 3, and various configurations can be used. It is sufficient as long as the plasma generator 102 has a configuration to produce products such as radicals that can decompose bacteria in the liquid flowing through the flow passage tube 101.

In embodiments 1 to 3, descriptions have been given with regard to examples in which bacteria present in liquid are killed inside the flow passage tube 101, and examples in which organic matters present in liquid are decomposed inside the flow passage tube 101; however, in the liquid treatment unit of the present disclosure, bacteria and organic matters do not have to be present in the liquid inside the flow passage tube 101. In other words, it is sufficient as long as the liquid treatment unit of the present disclosure has a configuration to produce products such as radicals that can kill bacteria in liquid and/or can decompose organic matters in liquid, and, in practice, bacteria do not have to be eliminated in the liquid to treatment unit, and organic matters does not have to be decomposed in the liquid treatment unit. Therefore, “treat liquid” in the present disclosure may refers only to radicals being produced in liquid, and whether bacteria in liquid are killed and/or organic matters in liquid are decomposed may be inconsequential. For example, the liquid treatment unit of the present disclosure includes a mode in which liquid not including bacteria or organic matters are supplied from an inlet, and liquid including radicals is ejected from an outlet. The “treatment efficiency of liquid” in the present disclosure may be the efficiency at which liquid that includes radicals is obtained.

With the liquid treatment unit of the present disclosure, by combining with another device, it is possible to perform sterilization in the other device using treated liquid ejected from the outlet. The other device may have a retention tank in which liquid that has been treated by the liquid treatment unit is accumulated, for example.

In the liquid treatment unit of the present disclosure, a portion of liquid is distributed from the liquid that flows through the flow passage tube, and the remaining liquid is recirculated through the flow passage tube. Thus, in the liquid treatment unit of the present disclosure, radicals having a long life span can be continuously maintained in the liquid that circulates inside the flow passage tube and in the liquid that is ejected from the flow passage tube, even when liquid is newly supplied. This is clear also from the experiment results depicted in FIG. 4 to FIG. 6.

### Other Application Examples

The liquid treatment unit of the present disclosure may be incorporated into a toilet seat with a washer. The toilet seat with a washer includes a washing nozzle. Liquid ejected from the flow passage tube of the liquid treatment unit is supplied to the washing nozzle. The toilet seat with a washer may include an input part to receive input that instructs washing from a user. In this case, the controller may execute the second step prior to the input from the input part, and execute the third step and eject the liquid inside the flow passage tube to the washing nozzle on the basis of the input from the input part. The toilet seat with a washer may include a sensor that detects the approach of a user. In this case, the controller may execute the second step on the basis of the sensor detection, and execute the third step and eject the liquid inside the flow passage tube to the washing nozzle on the basis of the input from the input part.

The liquid treatment unit of the present disclosure may be incorporated into a washing machine. The washing machine includes a washing tub. Liquid ejected from the flow passage tube of the liquid treatment unit is supplied to the washing tub. For example, the washing machine may include an input part to receive input that instructs the start of washing from a user. In this case, the controller may, based on the input from the input part, execute the second step and the third step, and eject the liquid inside the flow passage tube to the washing tub. For example, the controller may, based on the input from the input part, execute the second step and, at the timing at which detergent adhered to the clothing in the washing tub is rinsed out, execute the third step and eject the liquid inside the flow passage tube to the washing tub.

The liquid treatment unit of the present disclosure may be incorporated into a liquid treatment apparatus. The liquid treatment apparatus includes a water inlet that is connected to the outlet of the liquid treatment unit. The liquid treatment apparatus is, for example, a water purifying apparatus, an air conditioner, a humidifier, an electric shaver washer, a dish washer, a processing apparatus for hydroponic culture, an apparatus for circulating nourishing solution, a toilet seat with a washer, a water purifier, a washing machine, an electric kettle, or an air cleaner or the like.

Modes in which various modifications conceived by those skilled in the art have been implemented in the present embodiments or modified examples thereof, and modes constructed by combining constituent elements in different embodiments or modified examples thereof are also included in the scope of the present disclosure provided they do not depart from the purpose of the present disclosure. These comprehensive or specific aspects may be realized by a method.

For example, a liquid treatment method may include: a step in which liquid is circulated along a flow passage tube; a step in which plasma is generated in the liquid in the flow passage tube; and a step in which a portion of liquid is distributed from the circulated liquid, and the portion of liquid is ejected. The step in which the liquid is circulated and the step in which the plasma is generated are performed at the same time. In the present disclosure, a plurality of steps being “performed at the same time” only refers to there being a period in which the plurality of steps are executed at the same time, and whether the start times and the end times of the plurality of steps coincide may be inconsequential.

For example, in the step in which the portion of liquid is ejected, liquid may be supplied into the flow passage tube while the portion of liquid is ejected. Note that in the present disclosure, “B is performed while A is performed” only refers to there being a period in which A and B are executed at the same time, and whether the start times and the end times of A and B coincide may be inconsequential.

For example, the step in which the portion of liquid is ejected, and the step in which the plasma is generated may be performed at the same time.

For example, in the step in which the liquid is circulated, the supply of liquid into the flow passage tube and the ejection of liquid from the flow passage tube may be stopped for a predetermined time.

For example, the liquid treatment method may additionally include a step in which liquid is supplied into the flow passage tube, prior to the step in which the liquid is circulated.

For example, in the step in which the portion of liquid is ejected, liquid may be supplied into the flow passage tube while the portion of liquid is ejected, and in the step in which the plasma is generated, the plasma may be generated in the liquid in at least a partial area in the flow passage tube from the section where the liquid is supplied, to the section where the portion of liquid is ejected, in the direction in which the liquid is circulated.

For example, the liquid treatment method may additionally include a step in which gas included in circulated liquid is separated.

For example, the step in which the plasma is generated may additionally include a step in which a voltage is applied between a first electrode and a second electrode at least portions of which are arranged inside the flow passage tube.

For example, the step in which the plasma is generated may additionally include a step in which gas is supplied into a space formed between the first electrode and an insulator arranged around the periphery of the first electrode, and the step in which a voltage is applied may be executed in a state where an exposed portion of a conductor, which is positioned inside the flow passage tube, of the first electrode is covered by the gas supplied in the step in which gas is supplied.

For example, the step in which the plasma is generated may additionally include a step in which, by applying a voltage between the first electrode and the second electrode, liquid inside the space formed between the first electrode and the insulator arranged around the periphery of the first electrode is vaporized and gas is produced, and the step in which a voltage is applied may be executed in a state where the exposed portion of the conductor, which is positioned inside the flow passage tube, of the first electrode is covered by the gas produced in the step in which gas is produced.

For example, the liquid treatment method may additionally include a step in which an instruction from the user is received, after the step in which the liquid is circulated, prior to the step in which the portion of liquid is ejected.

For example, the liquid treatment method may additionally include a step in which an instruction from the user is received, prior to the step in which the liquid is circulated.

The liquid treatment unit according to the present disclosure is useful in applications for a water purifying apparatus, an air conditioner, a humidifier, an electric shaver washer, a dish washer, a processing apparatus for hydroponic culture, an apparatus for circulating nourishing solution, a toilet seat with a washer, a water purifier, a washing machine, an electric kettle, or an air cleaner or the like.

While the present disclosure has been described with respect to exemplary embodiments thereof, it will be apparent to those skilled in the art that the disclosure may be modified in numerous ways and may assume many embodiments other than those specifically described above. Accordingly, it is intended by the appended claims to cover all modifications of the disclosure that fall within the true spirit and scope of the disclosure.

What is claimed is:

1. A liquid treatment unit comprising:
an inlet for supplying liquid;
a flow passage tube connected to the inlet, the flow passage tube defining a circulation flow passage along which the liquid supplied from the inlet circulates;
a plasma generator that generates plasma in the liquid in at least a partial area of the flow passage tube to cause the liquid to be treated;
a distributor, provided midway in the flow passage tube, for distributing a portion of liquid from the liquid flowing through the flow passage tube; and
an outlet, connected to the distributor, for ejecting the portion of liquid from the flow passage tube.

2. The liquid treatment unit according to claim 1,
wherein the circulation flow passage includes a flow passage extending from the inlet to the distributor in the direction of the circulating flow, and
wherein at least part of the plasma generator is arranged in the flow passage.

3. The liquid treatment unit according to claim 1, further comprising:
a gas-liquid separator provided midway in the flow passage tube, the gas-liquid separator extracting gas from a mixture of the liquid and gas contained in the flow passage tube and emitting the gas to outside.

4. The liquid treatment unit according to claim 1, wherein the plasma generator comprises:
a first electrode at least a portion of which is arranged inside the flow passage tube;
a second electrode at least a portion of which is arranged inside the flow passage tube;
an insulator surrounding the periphery of the first electrode with a space therebetween, the insulator having an opening through which the space communicates with the inside of the flow passage tube;
a power source that applies a voltage between the first electrode and the second electrode; and
a gas supply device that supplies gas to the space.

5. The liquid treatment unit according to claim 4,
wherein at least part of the first electrode includes a region where a conductor surface thereof is exposed, and
wherein when the region is covered by the gas, the power source applies the voltage.

6. The liquid treatment unit according to claim 1, wherein the plasma generator comprises:
a first electrode at least a portion of which is arranged inside the flow passage tube;
a second electrode at least a portion of which is arranged inside the flow passage tube;
an insulator surrounding the periphery of the first electrode with a space therebetween, the insulator having an opening through which the space communicates the inside of the flow passage tube; and
a power source that applies a voltage between the first electrode and the second electrode.

7. The liquid treatment unit according to claim 6,
wherein at least part of the first electrode includes a region where a conductor surface thereof is exposed, and
wherein the power source applies the voltage, vaporizing liquid inside the space to produce gas, and causing discharge when the region is covered by the gas.

8. The liquid treatment unit according to claim 1, further comprising:
a controller that supplies liquid to the inlet while the portion of liquid is ejected from the outlet.

9. The liquid treatment unit according to claim 1, further comprising:
a controller that controls supply of the liquid into the flow passage tube via the inlet, and ejection of the liquid from the flow passage tube via the outlet,
wherein the plasma generator generates the plasma to cause the liquid to be treated, while the controller stops the supply of liquid and the ejection of liquid in a state where the liquid is present inside the flow passage tube, and
after the liquid has been treated, the controller resumes the supply of the liquid into the flow passage tube via the inlet, and causes a portion of the treated liquid to be ejected from the flow passage tube via the outlet while allowing remaining treated liquid to be circulated inside the flow passage tube.

10. The liquid treatment unit according to claim 9,
wherein the controller causes the liquid to be supplied into the flow passage tube via the inlet.

11. The liquid treatment unit according to claim 8,
wherein the plasma generator generates the plasma in the liquid inside the flow passage tube, when the portion of the liquid is ejected while the remaining liquid is circulated inside the flow passage tube.

12. The liquid treatment unit according to claim 9,
wherein, when the portion of the liquid is ejected while the remaining liquid is circulated inside the flow passage tube, the quantity of the liquid ejected from the flow passage tube is equal to or greater than the volume inside the flow passage tube.

13. A toilet seat with a washer comprising:
the liquid treatment unit according to claim 1; and
a washing nozzle to which the liquid ejected from the flow passage tube is supplied.

14. A toilet seat with a washer comprising:
the liquid treatment unit according to claim 9;
a washing nozzle to which the liquid ejected from the flow passage tube is supplied; and
an input part that receives an instruction of washing from a user,
wherein the controller stops the supply of liquid and the ejection of liquid prior to receiving the instruction from the input part,
the plasma generator generates the plasma in the liquid inside the flow passage tube, while the supply of liquid and the ejection of liquid are stopped, and
the controller, based on the instruction from the input part, causes the portion of the liquid to be ejected to the washing nozzle.

15. A washing machine comprising:
the liquid treatment unit according to claim 1; and
a washing tub to which the liquid ejected from the flow passage tube is supplied.

16. A washing machine comprising:
the liquid treatment unit according to claim 9;
a washing tub to which the liquid ejected from the flow passage tube is supplied; and
an input part that receives an instruction of starting washing from a user,
wherein the controller, based on the instruction from the input part, stops the supply of liquid and the ejection of liquid,
the plasma generator generates the plasma in the liquid inside the flow passage tube, while the supply of liquid and the ejection of liquid are stopped, and
the controller causes the portion of the liquid to be ejected to the washing tub after the liquid has been treated.

17. A liquid treatment apparatus comprising:
the liquid treatment unit according to claim 1; and
a water inlet connected to the outlet of the liquid treatment unit,
the liquid treatment apparatus being the one selected from the group consisting of a water purifying apparatus, an air conditioner, a humidifier, an electric shaver washer, a dish washer, a processing apparatus for hydroponic culture, and an apparatus for circulating nourishing solution.
